(19) United States
(12) Patent Application Publication
(10) Pub. No.: US 2002/0022406 A1
(43) Pub. Date: Feb. 21, 2002

(54) Electrical socket means and associated components

(75) Inventor: Gordon Hutchison, Warwickshire (GB)

Correspondence Address: JEFFER, MANGELS, BUTLER & MARMARO LLP, TENTH FLOOR, 2121 AVENUE OF THE STARS, LOS ANGELES, CA, 90067, US

(73) Assignee: Aphel Limited

(21) Appl. No.: 09/885,291

(22) Filed: Jun. 20, 2001

(30) Foreign Application Priority Data
Jun. 20, 2000 (GB) 0014903.9

(51) Int. Cl. H01R 25/00

(52) U.S. Cl. 439/652

(57) ABSTRACT

An electrical socket means has electrical contact means within a housing, the electrical contact means being formed of an integral or one-piece electrically conductive member having a socket portion for releasable engagement with plug means of an electrical device and securing means for locating and securing an electrical wire for supplying electrical power to the device. The securing means comprises a spring arm bearing resiliently against another part of the member for locating and securing the wire therebetween. An electrical socket assembly has a main body having one or more apertures for location of such an electrical socket means therein.

### INTRODUCTION

This invention relates to electrical socket means, in particular for use in plug and socket power supplies, and to associated components for the assembly thereof.

The invention has particular, but not exclusive, application to housings incorporating a plurality of sockets in one unit.

Power sockets have been proposed comprising a row of sockets in a housing so that power may be supplied through respective plugs to a plurality of electrically operated devices from a single power input. Such sockets should be reliable in operation, easy to assemble and capable of being mounted in a variety of applications.

It is an aim of the invention to provide improved electrical socket means.

### SUMMARY OF THE INVENTION

According to one aspect of the invention there is provided electrical contact means for supplying power to an electrical device, the contact means comprising an integral or one-piece electrically conductive member having:

a socket portion for releasable engagement with plug means of said electrical device; and

securing means for locating and securing an electrical conductor wire for supplying electrical power to said contact means;

wherein the securing means comprises a spring arm bearing resiliently against another part of said member for locating and securing said wire therebetween.

Preferably the arm is of curvilinear shape and engages resiliently with said socket portion of the member. The arm may present a portion inclined to the socket portion whereby the wire is insertable between the inclined portion and the socket portion to grip the wire by the arm after such insertion.

Preferably the inclined portion of the arm is divided longitudinally to provide parallel portions separated towards their free ends and extending integrally from the arm, one of said wires being locatable by each of said parallel portions.

According to a further aspect of the invention there is provided electrical socket means comprising at least one housing, apertures in the housing for admitting plug means, and electrical contacts within the housing with which the plug means is electrically contactable after insertion into the apertures, the housing being of regular octagonal shape in cross-section.

According to another aspect of the present invention there is provided an electrical socket assembly comprising a main body having at least one opening into which socket means, such as that defined in the preceding paragraph, may be located, the or each opening being shaped according to the cross sectional shape of the housing of said electrical socket means such that the socket means may be positioned in each opening in different positions displaced about a central axis thereof.

In a further aspect of the invention there is provided electrical socket means comprising a housing, electrical contact means within the housing, apertures in the housing for admitting plug means arranged to electrically contact the contact means, and resilient shutter means for closing the apertures in the housing when the plug means is not in position, the shutter means being movable in a direction transverse to said apertures to open the apertures by engagement during entry of the plug means.

Preferably, the shutter means includes a planar unitary member and spring means whereby to bias the unitary member towards a position over the apertures, the spring means being located between two portions of the unitary member and against a portion of the housing.

According to a further aspect of the invention there is provided an electrical socket assembly comprising a plurality of electrical socket means, for example such as those previously described, an elongate main body into which the socket means are located end to end, the main body having electrical conductor means for electrical connection to the contact means, and mounting means arranged for mounting the body on support means.

Conveniently the mounting means may include a mounting element adjustably movable between an operating and non-operating position wherein in the operating position the mounting element extends outwardly of the main body. A mounting element may extend from one or both ends of the body.

Additionally or alternatively mounting means may also be provided to locate the main body at its underside, for example, mounting elements may be arranged to clip on to the main body at selected positions along said body.

The main body may be formed of longitudinal extrusions arranged to fit together and may have cap means at each end for sealing the ends and for leading electrical conductors from an external power supply.

### BRIEF DESCRIPTION OF THE DRAWINGS

The present invention will now be described, by way of example only, with reference to the accompanying drawings, in which:

FIG. 1 is a perspective view of a preferred form of electrical socket assembly according to the invention and its assembled components;

FIG. 2 is a perspective view corresponding to FIG. 1 with the components disassembled;

FIG. 3 is a perspective view of a preferred form of electrical socket means according to the invention disassembled,

FIG. 4 is a perspective view of one end of the socket assembly of FIG. 1 showing attachment means, from the upper side;

FIG. 5 is a view corresponding to FIG. 4 showing attachment means, from the underside;

FIG. 6 is a perspective view of an end of the socket assembly of FIG. 1 showing an arrangement for connection to a power supply, and

FIG. 7 is a view corresponding to FIG. 6 of another arrangement for power supply connection.

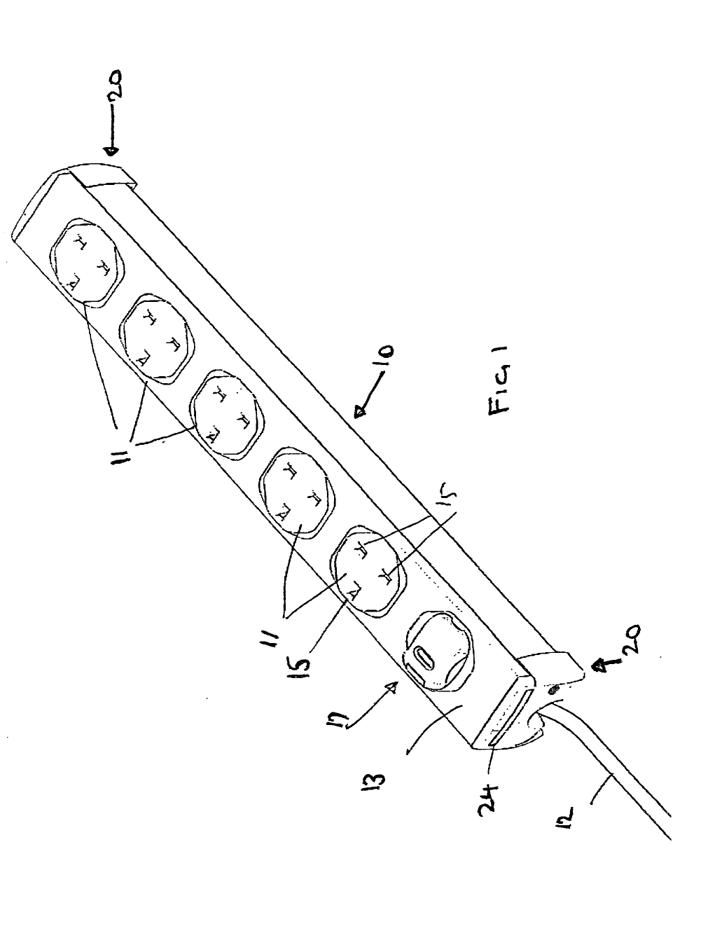

### DESCRIPTION OF THE PREFERRED EMBODIMENT

Referring to the drawings, an electrical socket assembly includes an elongate main body 10 into which is located housings 11, each defining a respective electrical socket, spaced apart end to end within the body 10. Power is supplied to the body 10 through a cable 12 connected to a power source (not shown).

The body 10 is provided on its upper side 13 with a series of openings 14 (in this case 5 openings) which are spaced apart in a row and the openings are formed to be of octagonal shape having eight equal length sides. The housings 11 are formed so that they are also generally octagonal for location within the openings 14. By this arrangement the housings 11 may be located in a selection of positions displaced from one another about the central axis of the housings 11, each position being displaced from the other about 45°.

Each of the housings 1 is formed on its upper side with apertures 15 the apertures being arranged to admit a conventional three pin plug (not shown) by which electrical contact is made with contacts within the housings 11. In conventional manner one of the openings 15 is for a plug earth pin. It will be appreciated that in the various positions of the housings 11 in the body 10 the disposition of the openings 15 will change so that the conductor passing from the plug can be directed in different directions from the housing 10. Thus the wire or cable from each plug may extend longitudinally of the housing 10, in one direction or the other; at a right angle to the longitudinal direction, in one direction or the other; or at 45° to said longitudinal direction, in one direction or the other. This gives significant advantages in enabling the user to select the best arrangement for the housings 11 in relation to the intended uses of the socket assembly. The assembly may also include a switch means 17 by which power from the cable 12 may be switched to the housings 11.

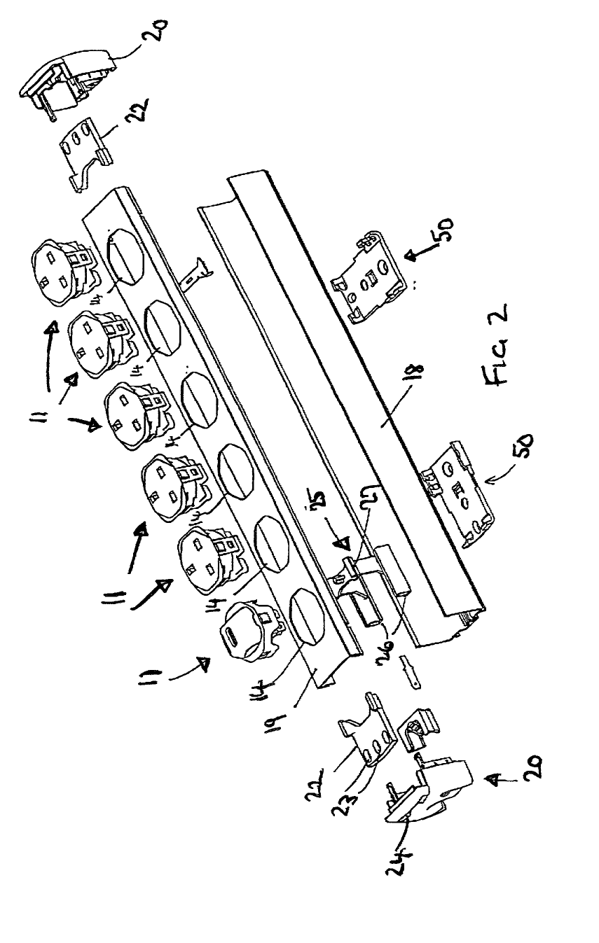

The main body 10 is formed of an assembly of components, as best seen in FIG. 2. These components include a channel section extrusion 18 which is arranged to be clipped together with an apertured extrusion 19, the extrusion 19 defining the openings 14 for the housings 11 and for the switch 17. The body 10 has end caps 20 at each end and at one of the ends, the left-hand end as seen in FIG. 2, there are located components by which the cable 12 is electrically connected to the main body 10, as will be described. The end cap 20 at this end is formed with openings for receiving the cable 12 and, as illustrated, an earthing wire 21.

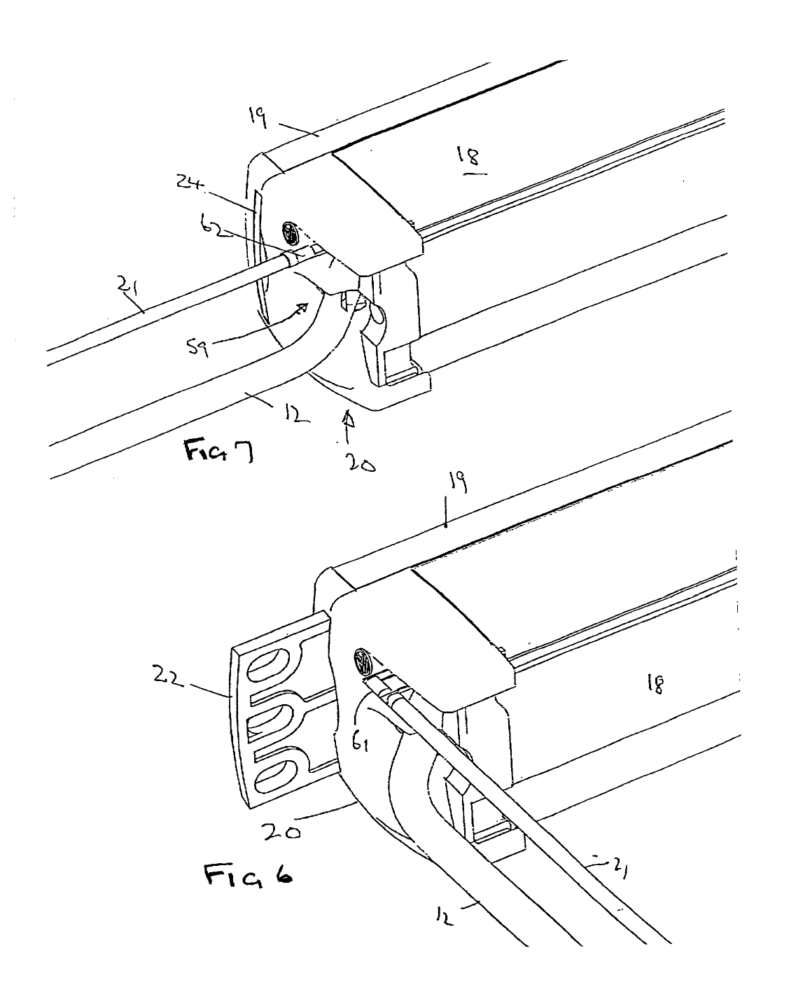

Fixing brackets 22 are provided at each end of the body 10 and are located movably in relation to the body. The brackets 22 are held captive by the extrusion 19 but are movable between a position partially or wholly within the body 10 and a position in which the ends of the brackets protrude beyond the ends of the body 10, such position being shown in FIG. 6. The brackets 22 are formed with apertures 23 by which the bracket 22 and hence the body 10 may be secured to associated structure (not shown). The brackets 22, in their extended position, project through slots 24 formed in the associated end caps 20.

A power connection element 25 is provided in the channel section member 18 towards the end of the body 10 to which power is supplied. The element 25 is dimensioned to be a close fit within the channel with depending legs 26 seated in the corners of the base of the channel 18. Towards the upper end of the element are located conductor wire connectors 27 to which the input wire conductors are connected and from which connectors distribute through wires (not shown) power to the individual elements 11. The element 25 also acts as a heat sink for heat generated within the element, the heat sink function being assisted by the element 25 being in close contact with the walls of the channel section 18.

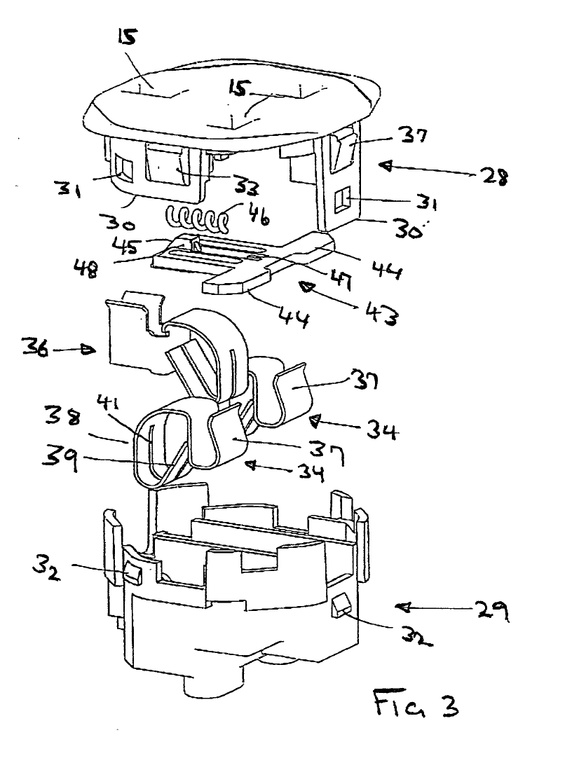

FIG. 3 shows a preferred form of electrical socket according to this invention. Bach socket is made up of an upper component 28 assembled with a lower component 29. Location of the components 28 and 29 together is facilitated by the provision of arms 30 depending from the upper component and each arm 30 having an aperture 31 into which an inclined protrusion 32 or component 29 is arranged to engage when the upper and lower components are brought together. The arm 30 also has an inclined protrusion 33 arranged to locate the socket when located in position on the main body 10. It is the upper component 28 which is formed with apertures 15 for receiving a plug (not shown) to be releasably locatable in the sockets defined by the socket.

Located within the socket after assembly is electrical contact means in the form of three contact elements of which two 34 are arranged to co-operate with the live and neutral pins of the plug, and the other 35 is arranged for contact with the earth pin of the plug. The contact elements 34 are the same and each comprise an integral or single-piece of resilient metal which is shaped to the configuration shown in FIG. 3 to define a socket portion 37 having a generally U-shape, narrower towards its upper end into which the respective pins are located when the plug is in position. Due to the converging shape of the portions 37 the pin is gripped.

The remaining, integral portion 38 of each contact element 34 provides means for locating one or two conductor wires in electrical connection with the element. The portion 38 is integral with the socket portion 37 and is of generally curvilinear shape having an inclined portion 39 which resiliently bears against engages with part of the socket portion 37. The portion 38 is formed with a longitudinal slot 41 which extends to the free end of the inclined portion 39 to provide two parallel portions separated by the slot 41.

The inclined portion 39 is arranged to locate conductor wire which may be inserted by pushing up from below, as seen, between the free end of the inclined portion 39 and the socket portion 37, the resilience of the material permitting such insertion whilst retaining the wire in position after insertion. Due, in part, to the resilience of the material and the inclination of the portion 39 wire is firmly retained in the element 34 in electrical contact therewith. It will be understood that two conductor wires can be assembled with the element, one to each side of the longitudinal slot 41.

The earth contact 35 is constructed similarly but is orientated differently to accommodate the earth pin of the plug.

The arrangement of the contact elements 34 and 36 permits the conductor wires to be firmly attached thereto and retained without the use of other fixings, such as screws. This makes for easy assembly whilst retaining the required electrical contact and durability of the connection Each of the elements 34 and 36 are made out of a single piece of resilient metal by an efficient stamping and bending operation.

The contact elements 34 and 36 are located in suitably formed compartments within the lower component 29, the wires for the elements extending through openings formed in the component 29.

Also housed within the socket is a shutter mechanism 43 by which the openings 15 are closed when there is no plug located within the housing 11. The mechanism 43 is generally of T-shape having two oppositely-extending arms 44 of the T which are locatable directly under the apertures 15 for the live and neutral pins. A chamfered surface 45 is located under the earth pin aperture 15 for engagement by the earth pin upon entry and to cause the mechanism 43 to be moved to reveal the other two apertures 15 to enable the respective pins to enter the housing 11.

The mechanism 43 locates a compression spring 46, one end fitting over a lug 47 and the other end engaging with a portion 48 on which the chamfer 45 is formed. When the shutter mechanism 43 is located on the underside of the upper component 28 it is held captive and the spring 46 engages with lugs on the underside of upper component 28. Thus it is able to be moved against the spring resistance of the spring 46.

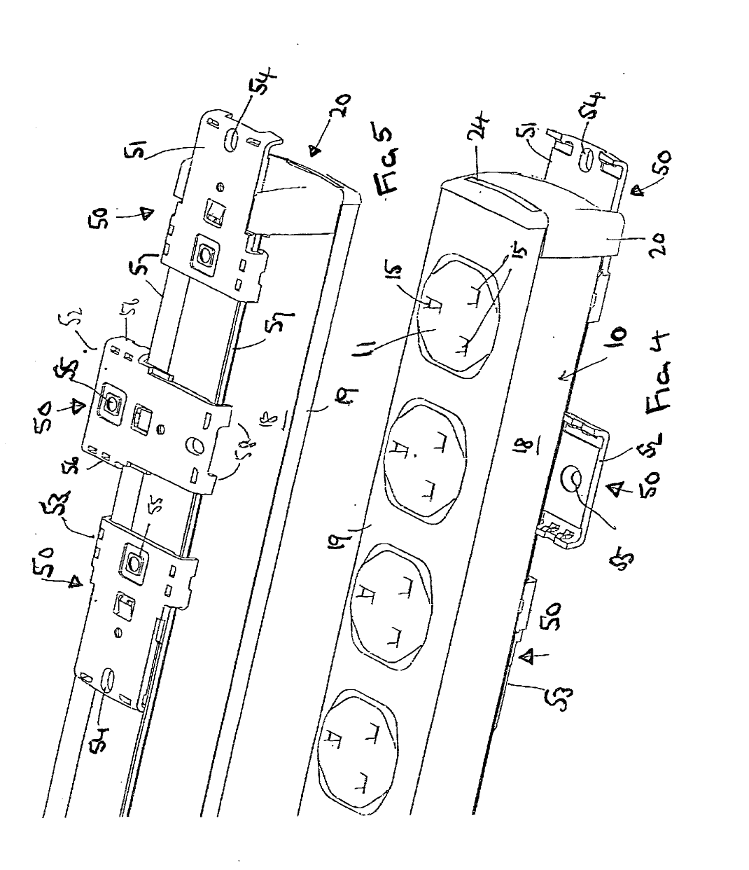

Referring now to FIGS. 4 and 5 there are shown various arrangements by which the assembly may be mounted making it possible to effect a mounting for different applications. As seen in FIGS. 4 and 5 a bracket 50 is locatable in several different positions. In position 51 the bracket extends from the underside of one end of the body 10 and, in the projecting part, there is an opening 54 for locating a securing device. In position 52 the bracket 50 has a portion projecting to one side of the body 10 and has an opening 55 for location of a securing device. In the position 53 the bracket 50 lies along and under the body 10 and is usually located in relation to a mounting using opening 55 or opening 54 before the main body 10 is located on the bracket 50.

In each position the bracket 50 is adapted to locate on the underside of the main body 10 and for this purpose it is formed with clip members 56. The clip members 56 are located towards one end of the bracket and are dimensioned to clip over the underside of the body 10, as in positions 51 and 53. In this arrangement the clip members 56 locate over lips 57 formed along the lower side edges of the lower component 29.

There is also provided clips 58 which together with the inner edges of the clips 56 clip over the lower side of the body 10 engaging with the lips 57. In this arrangement the bracket 50 lies at a right angle, as seen in position 52, compared with the positions 51 and 53. The opening 55 is then presented to the side of the body.

The brackets 50 present a flexible and adaptable arrangement for mounting the main body depending on the mounting arrangement to be employed, the brackets being repositionable at the ends, or at any position between the ends of the body, and in either a sideways projecting mode or a concealed position.

Referring now to FIGS. 6 and 7 there is shown two arrangements for enabling the cable 12 and wire 21 to extend from one end of the body. In the arrangement shown in FIG. 6 the cable 12 and wire 21 are arranged to extend away from the body to one side there of whereas in the FIG. 7 arrangement the cable 12 and wire 21 are arranged to extend in the generally longitudinal direction of the body 10.

The arrangement of FIG. 6 is made possible by providing a contoured opening into the associated end cap 20 so that the cable may be turned through an angle within the contoured opening illustrated at 59. The wire 21 is turned through a right angle by provision of an adaptor 61 by which the wire is able to extend transversely of the body after connection to an internal conductor within the end cap 20. In the FIG. 7 arrangement the adaptor 61 is a rectilinear member 62.

The electric socket assembly described provides various advantages in assembly, in mounting, in the configuration of the socket housings and hence the plugs, and in giving good mechanical strength and durability.

In one additional feature there may be provided another way in which the shutter mechanism 43 may be operated. An additional opening may be provided in the upper component 28 of the housing 11 for the entry of a shutter operating pin (not shown) which may be attached to the conventional plug by adhesive. In this arrangement insertion of the supplemental pin releases a locking mechanism in the socket which permits the earth pin of the plug to move the shutter mechanism upon insertion. As before, movement of the shutter mechanism allows full insertion of the plug pins. The additional pin is arranged to engage the shutter mechanism to release it by the pin being longer than the electrical contact pins. This arrangement ensures that only plugs having the supplemental pin can be inserted in the socket.

1. Electrical contact means for supplying power from a conductor wire to an electrical device having plug means connected thereto, the contact means comprising an integral or one-piece electrically conductive member having:
a socket portion for releasable engagement with said plug means of said electrical device; and
securing means for locating and securing said electrical conductor wire for supplying electrical power to said contact means;
wherein the securing means comprises a spring arm bearing resiliently against another part of said member for locating and securing said wire therebetween.

2. Electrical contact means according to claim 1 wherein said arm is of curvilinear shape and engages resiliently with said socket portion.

3. Electrical contact means according to claim 1 wherein said arm presents a portion inclined to said socket portion whereby said wire is insertable between said inclined portion and said socket portion thereby to grip said wire by said arm after such insertion.

4. Electrical contact means according to claim 3 wherein said inclined portion of said arm is divided longitudinally to provide separated, parallel portions extending integrally from said arm, each of said parallel portions being arranged for locating and securing a respective wire.

5. Electrical socket means comprising;
housing;
at least one electrical contact means according claim 1 within said housing; and
a plurality of apertures in said housing for admitting said plug means for electrical contact with said contact means.

6. Electrical socket means according to claim 5 wherein said housing is of regular, polygonal shape in cross section.

7. Electrical socket means according to claim 6 wherein said regular polygonal shape is octagonal.

8. Electrical socket means according to claim 5 further comprising shutter means for closing said apertures in said housing when said plug means is not in position, said shutter means being movable in a direction transverse to said apertures thereby to selectively open said apertures for engagement of said plug means with said contact means.

9. Electrical socket means according to claim 8 wherein said shutter means comprises:
a planar, unitary member; and
spring means for biassing said unitary member towards a position in which said apertures are closed;
wherein said spring means is located between two portions of said unitary member and against a portion of said housing.

10. An electrical socket assembly comprising a main body having at least one opening therein, the or each opening being arranged for location of a respective electrical socket means according to claim 5.

11. An electrical socket assembly according to claim 10 wherein the or each opening is shaped according to said polygonal shape of said housing whereby said housing may be located in a respective opening in different rotational positions displaced about a central axis of the housing.

12. An electrical socket assembly according to claim 10 further comprising mounting means arranged for mounting said body on support means.

13. An electrical socket assembly according to claim 12 wherein said mounting means includes a mounting element, adjustably movable between operating and non-operating positions, wherein in said operating position said mounting element extends outwardly of the main body and wherein in said non-operating position said mounting element is recessed partially or wholly within said main body.

14. An electrical socket assembly according to claim 13 wherein a respective mounting element is provided at one or both ends of said body.

15. An electrical socket assembly according to claims 13 wherein said mounting means additionally or alternatively comprises at least one bracket arranged to clip on to the underside of the main body at selected or predetermined positions therealong.

16. An electrical socket assembly according to claim 10 wherein said main body is formed of two or more longitudinal extrusions arranged to fit together and is provided with cap means at each end for sealing the ends and leading electrical conductors into said body from an external power supply.
